(19) United States
(12) Patent Application Publication
(10) Pub. No.: US 2006/0288056 A1
(43) Pub. Date: Dec. 21, 2006

(54) File version management device, method, and program

(75) Inventors: Satoshi Yamakawa, Tokyo (JP); Takashi Torii, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/452,311

(22) Filed: Jun. 14, 2006

(30) Foreign Application Priority Data
Jun. 17, 2005 (JP) 2005-178193

(51) Int. Cl. G06F 17/30

(52) U.S. Cl. 707/203

(57) ABSTRACT

Disclosed is a version management device which comprises a file access verification unit that receives a request packet sent from the client and a response packet sent from the server, extracts a processing request and a response result from the packets, and checks if the processing request and the response result match an access pattern corresponding to a file data update processing operation by an application running on the client; a user management unit that manages user information in a format defined for each file access protocol to verify from which user the processing request, included in the request packet from the client, is issued; a version control unit that controls the creation operation of a version management file when it is found that an operation corresponding to processing pattern corresponding to file data update processing by the application running on the client is executed in the file access verification unit; and a setting information management unit that holds operation setting information required by the file access verification unit, the user management unit, and the version control unit for their operation.

### FIELD OF THE INVENTION

The present invention relates to an apparatus, method, and computer program, each performing version management of a file.

### BACKGROUND OF THE INVENTION

<Existing File Management Storage Device>

NAS (Network Attached Storage) and a file server are devices that allow multiple client machines to share files, generated by multiple client computers, via a network.

A server device is compatible with a file access protocol, such as the NFS (Network File System) protocol or the CIFS (Common Internet File System) protocol supported by a general-purpose client device as an industry-standard protocol, to allow the user to use the server device without adding special software or hardware during installation. The user can use the file manager, installed on the client, to access the files in the server device via the NFS protocol or the CIFS protocol as if those files were stored in the local file system on the client machine.

Data in a file, once stored in a server storage device, can be updated by a client machine using the NFS protocol or CIFS protocol. However, after the storing of updated data is completed in the server storage device, the client cannot access the file in the state before the data update again.

Therefore, the problem is that, in case user-required data is lost due to a user's operation error or an unexpected data update by other users, the user cannot get the user-required data.

<Existing File Version Management System>

To solve this problem, the following storage devices have been proposed:

Storage device in which multiple versions of a file are saved in conjunction with data update history

Storage device having the function called “snapshot” that regularly saves the state of a file at a particular moment and provides the client with the file data saved at the moment with the data arranged in time-series.

A storage device, which saves multiple versions of a file in conjunction with data change history, usually provides the client with the following function to process a file already stored in the storage device:

Function to download the data of the

Function to replace the data of an already-stored file by uploading a file whose data has been updated

When the client performs the data upload operation, the storage device judges that the version of the file is updated. Instead of deleting the data that has been stored in the storage device before the upload operation, the storage device saves the uploaded data and the upload history with an index created for them, thus managing the file data of multiple versions in conjunction with the data update history.

In this case, the download or upload operation in conjunction with the data update history is performed using an application, an interface, or a protocol specific to the storage device. Thus, unlike a file saved in NAS or a file server, the client cannot deal with a file, saved in the storage device, in the same way as a local file of the client via the file manager.

This require the user to use an application or an interface, different from that used in the operation of client's local files, to edit a file stored in the storage device.

On the other hand, a storage device with the snapshot function saves data as follows. Triggered by a snapshot command scheduled or directly entered by a storage administrator, the storage device saves the data at the time the command is entered and keeps the data without adding a change to it even if the client updates the data later. In this way, multiple versions of data can saved with indices in association with time series of command execution.

This allows the user to access the data of a file with a past version based on the time at which the snapshot command was entered.

However, a file version created by the snapshot command is not synchronized with the edit operation of the file by a user. Therefore, a file cannot be saved in a user-intended status nor can the user always access desired data.

To solve such a problem in the file version management system, Non-Patent Document 1 proposes a special network bridge device provided between an existing file server and a client machine network. This network bridge device (file update history saving system) extracts operation information on the update of NFS protocol packets to manage file versions while reflecting the update data in the storage area in the bridge device. This system monitors packets transferred between the clients and the server and saves the file update history. This device (system) solves the problem of the inconvenience of a client machine in the conventional file version management system, which can be used only via a special interface, and the problem of incomplete update history data in the file version management caused by a snapshot that is not synchronized with the update operation of the client.

[Non-Patent Document 1]

Masayuki Tanemura, Yasushi Shinjo, Kozo Itano, Shigeru Chiba “Preserving File Update History with a network Monitoring Technique” IPSJ (Information processing society of Japan) Journal Computing System Vol. 44 No. SIG10 (2003)

### SUMMARY OF THE DISCLOSURE

To manage file versions in an environment where multiple clients share data using a file server, file version management is required that uses an existing interface compatible with the standard file access protocol on the client side and that is synchronous with update processing on the client side. To meet this need, the system such as the one disclosed in Non-Patent Document 1 described above is efficient, because the system extracts all update requests issued via the standard file access protocol and creates multiple versions of files synchronously with the update request.

However, even if information data on all update processing transferred to the file server are kept as the history data, all file history data is not necessarily useful to the user. For example, an application that generates or updates a file sometimes creates a temporary file only for temporarily saving data before generating the final file on which the file update data is reflected. Although meaningful to a specific application, a temporary file is automatically deleted by the application after the desired file is generated or data is saved and, therefore, the user does not access the temporary file intentionally.

As described above, the technology proposed in Non-Patent Document 1, if used, would extract all requests about the update processing executed via a file access protocol and unconditionally collect history data on the file data in the whole file system. The problem is that even data that will not be accessed intentionally by the user, such as a temporary file, is saved as the history data and therefore the storage resources for storing the history data are used wastefully.

Accordingly, it is an object of the present invention to provide a device that allows the user to save history data in a storage device without worrying about the version creation operation while avoiding waste in the storage area.

The above and other objects are attained by the present invention that automatically create and save history data only on the files meaningful to the user to implement an efficient storage operation.

The file version management device according to the present invention is advantageously applicable to a device that is added to a network-connected file storage device used as a data-sharing device in a computing environment. The file version management device according to the present invention is advantageously applicable to a device that manages a difference in versions which occurs when file data stored in a file storage device is updated by plural client machines.

A version management device according to the present invention analyzes the command context (for example, a sequence of a command request, a response to the request, etc.) of an access to a file, determines whether the command context matches a predetermined pattern and, if the command context matches the predetermined pattern, creates version management information according to the predetermined pattern.

The version management device according to the present invention, provided for use in a usual remote file access environment in which access is made to a file server or NAS using the NFS protocol or the CIFS protocol, extracts a file access pattern generated synchronously with a predetermined file update processing operation of an application to produce the history data of only the files, whose history is meaningful to the user, as files.

The present invention provides either a file server that has a function that analyzes an access request sent from a client machine using the NFS protocol or the CIFS protocol and a file version management function that operates synchronously with the analysis result or a switch device, installed in the preceding stage of an existing file server, that has the analysis function and the version management function described above as well as a function that relays a file access protocol packet between a client machine and a file server.

According to the present invention, the file version management function comprises means for verifying if an operation request and an operation result extracted from file access packets match a file access pattern that is pre-registered by a file server administrator and that is synchronous with the update processing operation of an application and means for creating a version management file if a file access packet is received which matches the processing pattern of the file update operation performed by the application.

A version management device according to the present invention comprises: storage means for storing a pattern of a data saving access operation, said data saving access operation being one of file access operations; and control means for analyzing a file access request, issued to a file, comparing the request with said pattern stored in said storage means and for extracting a file access, which matches said pattern, to control creation of a version management file.

Preferably in the version management device according to the present invention, an access pattern that is generated when data is saved and a procedure for creating the version management file are registered in said storage means in advance, and said control means analyzes the file access request to the file and, based on the pattern and the procedure, determines when the version management file is to be created and controls a creation operation of the version management file.

Preferably in the version management device according to the present invention, said version management device functions as a switch device that relays a file access request, sent from a client to a server, and transfers the file access request to said server, and transfers a response, sent from said server to said client in response to the request, to said client and monitors the request and the response transferred between said client and said server to check if the file access request matches the pattern.

Preferably in the version management device according to the present invention, said storage means stores a file update processing pattern of an application running on said client, which is a trigger for the creation of the version management file; wherein said version management device further comprises:

means for receiving a file access protocol packet transferred between said client and said server,

means for monitoring if an access pattern, which matches the file update processing pattern, is generated when the packet is transferred to the server or the client that is a destination, said file update processing pattern being registered in advance as a trigger for starting the creation of the version management file, and

means for creating the version management information, if an access pattern that matches the file update processing pattern is detected.

A version management device, according to the present invention, is a device that relays and transfers a request received from a client to a server and relays and transfers a response to said client, said request being a server-destined request sent using a pre-defined predetermined file access protocol, said response being sent by said server to said client in response to said request, wherein the device comprises: a file access verification unit, receiving a request packet sent from said client and a response packet sent from said server, for extracting a processing request and a response result included in the received request packet and response packet respectively, and checking if the processing request or the response result matches an access pattern corresponding to a file data update processing operation by an application running on said client;

a user management unit for storing and managing user information in a format corresponding to the predetermined file access protocol to verify from which user the processing request included in the request packet sent from said client is issued;

a version control unit for controlling creation of a version management file when it is found in said file access verification unit that an operation corresponding to the pattern corresponding to the file data update processing by the application running on said client is executed; and

a setting information management unit for storing operation setting information referenced during an operation of said file access verification unit, said user management unit, and said version control unit.

Preferably in the version management device according to the present invention, an access pattern generated when the application running on said client saves data in said server and a procedure for creating the version file are registered in advance in said setting information management unit and

the decision of when to create of the version management file and the control of the creation operation of the version management file are conducted based on the pattern and the procedure.

Preferably in the version management device according to the present invention, in addition to a usual file data storage area of said server, said version control unit creates a version file data storage area, in which a version management file is stored, in a predetermined file system,

a version management file storage area is arranged in a directory path in the version file data storage area, said directory path being equivalent to a directory path in the usual file data storage area and

said client can access data of a past generation of a file stored in the version management file data storage area based on a path name of the file stored in the usual file data storage area.

Preferably in the version management device according to the present invention, in addition to a usual file data storage area of said server, said version control unit creates a version management file data storage area, in which a version management file is stored, in a predetermined file system and a version management file for managing file update history data is saved in the version management file data storage area with a file name assigned, said file name including a creation date/time of the version management file, a name of a user who executed an operation for starting version creation, and a version number for generation management.

Preferably in the version management device according to the present invention, when a directory is laid open to said client as a shared directory in said server, a directory corresponding to the directory is created in the version management file data storage area,

a name not conflicting with a shared name of the directory in the usual file data storage area is assigned to the directory created in the version management file data storage area and the directory is opened to said client so that said client can access the directory as a read-only shared directory,

objects, which are arranged below the shared directory in the usual file data storage area and which are to be on a path to a version management file storage location, are created in the version management file data storage area when a new version management file is created,

if an object on the path to the version management file storage location is a directory, a directory with the same name as that of the directory in the usual file data storage area is created and, if an object below the directory is a file, a directory with a directory name, generated by adding information specific to the version management device to a file name of the file in the usual file data storage area, is created and

a version management file for managing file update history data of the file is saved in the directory with a file name assigned, said file name composed of a creation date/time of the version management file, a name of a user who executed an operation for starting version creation, and a version number for generation management.

Preferably in the version management device according to the present invention, on said client a document creation application is executed, said document creation application having a function in said version management device to create a first temporary file, in which unsaved editing file data is temporarily stored, and a second temporary file, in which data before a data update is temporarily stored, to prevent a user from losing unsaved update data and data of a file to be edited; and generation processing of the first temporary file or the second temporary file and reflection processing of update data from the first temporary file to the file to be edited are extracted for starting version management file creation that is synchronous with a user's data saving operation,

the second temporary file, in which data before a data update is stored, is stored in the file version data storage area as a version management file of an old version after the reflection processing of update data is executed but before the application executes a deletion request during the creation of the version management file and

the version management file is created for all files created by the document creation application.

Preferably in the version management device according to the present invention, when said file access verification unit extracts a file name duplication error in response to a file creation request, followed by an open request or a write request, said version control unit starts the version management file creation that is synchronous with a file overwrite saving operation.

Preferably in the version management device according to the present invention, when creating the version management file, the copy source file is stored in a file version data storage area as the version management file of an old version either after an open request is executed successfully and before a write request is executed in one file access protocol or when a write request is sent in another file access protocol.

Preferably in the version management device according to the present invention, said setting information management unit includes:

a server address or a computer name for version management

a shared name of a directory opened to the client and

a condition for creating the version management file synchronously with a saving operation of an application running on the client.

Preferably in the version management device according to the present invention, the condition includes at least one of the access request and the response result based on an operation of an associated application, a keyword of a file name corresponding to the operation request, a corresponding protocol, and an acquisition of a version management file storage destination and a version management file data copy source required for creating the version management file.

Preferably in the version management device according to the present invention, a user name is extracted from a user ID by associating the user name and the user ID specified for login processing and logoff processing requested by packets relayed between the client and the server.

Preferably in the version management device according to the present invention, if the processing request included in extracted request processing information of a request packet sent from said client to said version management device and then transferred to said file access verification unit matches a processing pattern which is a trigger for the creation of the version management file and is registered in said setting information management unit, a path name of a file to be processed, an ID of an operation request, a user ID, and a command name are extracted and then associated and saved in said file access verification unit as a processing request entry and, after that, the request packet is transferred to said server,

a response packet from the server, which corresponds to a response to the request, is extracted based on a request ID and, if it is found that the response result matches the processing pattern which is a trigger for the creation of the version management file, a flag is attached to the request entry indicating that the response result satisfies the processing pattern and, after that, the response packet is transferred to said client, and

if it is found that the response result does not match the processing pattern which is a trigger for the creation of the version management file, data included in the request entry and registered at the request time is deleted and, after that, the response packet is transferred to said client.

Preferably in the version management device according to the present invention, an already executed operation request is temporarily registered in the request entry and a related operation request is added to the same request entry and, if the processing pattern which is a trigger for the creation of the version management file matches the operation request and the response result, said file access verification unit searches said user management unit for a user name matching the user ID saved in the request entry and, based on the setting information registered in said setting information management unit, acquires a file path name of a copy source of version management file creation from the request entry.

Preferably in the version management device according to the present invention, said file access verification unit generates a path name of a copy destination of version management file creation from a path name according to a procedure for storing version management files in the version management file storage area and transfers the generated path name, as well as a user name and a file path name of a copy source, to said version control unit; and

said version control unit acquires data of a file, which is stored in the path name in a usual file data storage area, and attribute information thereof from said server based on the file path name of the copy source acquired from said file access verification unit, creates a new version management file in a version management file data storage area based on the path name of the copy destination acquired from said file access verification unit, and copies the data and the attribute.

Preferably in the version management device according to the present invention, if there is neither an existing version management file nor a directory to a copy destination, when creating the version management file, said version control unit first generates data of the directory and then creates the version management file.

Preferably in the version management device according to the present invention, when a new version management file is created, said version control unit acquires a version number of a version management file, which is latest before creating the new version management file, from a file name of the version management file stored in a directory where the new version management file is to be stored and assigns a file name, composed of a user name acquired from the file access verification unit, a version management file creation date/time, and a version number generated by adding 1 to the acquired version number, to the new version file.

Preferably in the version management device according to the present invention, said version control unit sends a version management file creation completion notification to said file access verification unit after the creation of the version management file is completed; and said file access verification unit deletes the request entry associated with the version management file.

Preferably in the version management device according to the present invention, if the request processing does not match the processing pattern which is a trigger for the creation of the version management file or none of login processing and logoff processing in said file access verification unit, the request packet from said client is transferred directly to said server; and if a response packet does not match the processing pattern which is a trigger for the creation of the version management file, the response packet from said server is transferred directly to said client.

Preferably in the version management device according to the present invention, to make said version management device compatible with a system where session management means is not provided for login processing and logoff processing, a user name to user ID correspondence table, stored in a NIS (Network Information Service) server or said server, is registered in said user management unit in said version management device.

Preferably in the version management device according to the present invention, a file is handled not by a path name but by a file handle, an operation is performed in which a path name beginning at a parent directory of the version management file and ending at the open directory is derived from a file handle of a file for which version management file creation is to be performed when the version management file is created, and the operation is performed until the open directory is reached, said operation being performed in such a way that a file handle of the parent directory is acquired by the file handle and the file name, a directory entry is acquired by using the file handle of the parent directory, and a search for a directory name having the acquire file handle is executed.

According to another aspect of the present invention, a version management method comprises the steps of analyzing a command context regarding an access to a file to determine whether the command context matches a predetermined pattern which is registered as a trigger for the creation of a version management file of the file; and creating and saving the version management file of the file if the command context matches the predetermined pattern which is a trigger for the creation of the version management file.

According to the present invention, a version management method may comprises a first step, by a version management device that automatically manages a file version, for receiving a request packet of file processing, for determining if a processing request content of the request packet matches a pre-registered pattern and, if a match occurs, for storing information on the processing request content;

a second step, by the version management device, for receiving a response packet that is a response to the request packet, for determining if the processing request content stored in the first step and a processing result of the response packet match a condition for triggering for starting the creation of a version management file of the file and, if a match occurs, registering information indicating that the processing request is completed; and

a third step, by the version management device, for repeating the first step and the second step until all processing as a trigger for starting the creation of the version management file is completed and, based on the stored request content, for creating the version management file.

According to still another aspect of the present invention, a program for automatically creating a version management file causes a computer to analyze a command context regarding an access to a file to determine whether the command context matches a predetermined pattern which is registered as a trigger for the creation of a version management file of the file; and create and save the version management file of the file if the command context matches the predetermined pattern which is a trigger for the creation of the version management file. The computer program, recorded on a computer-readable recording medium, is read into the main storage of the computer for execution to implement the processing described above.

The meritorious effects of the present invention are summarized as follows.

The use of the file server or the switch device according to the present invention allows the user to save history data without worrying about the version creation operation in a standard remote file access environment where an interface provided only for file version management is not used and the NFS protocol or the CIFS protocol is used. This improves convenience and, at the same time, automatically creates history data only on the files meaningful to the user, thus making the storage operation more efficient without wasting a storage area for saving history data.

Still other features and advantages of the present invention will become readily apparent to those skilled in this art from the following detailed description in conjunction with the accompanying drawings wherein only the preferred embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram showing an example of the configuration of a version management system in one embodiment of the present invention.

FIG. 2 is a diagram showing the configuration of a version management device in one embodiment of the present invention.

FIG. 3 is a diagram showing an example of the storage of version files in one embodiment of the present invention.

FIG. 4 is a diagram showing the operation procedure for saving updated data in a document creation application in one embodiment of the present invention.

FIG. 5 is a flowchart showing a version file creation procedure in one embodiment of the present invention.

### PREFERRED EMBODIMENTS OF THE INVENTION

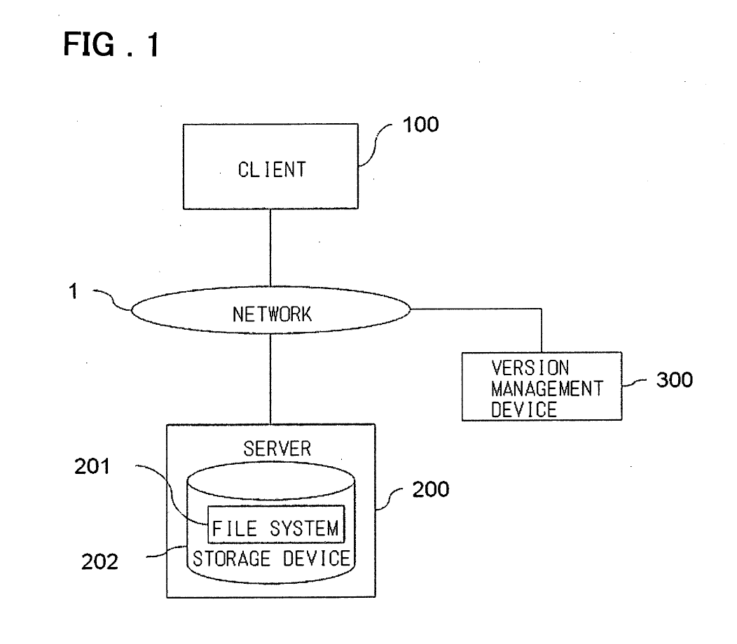

A system which embodies the present invention will be described with reference to the drawings. FIG. 1 is a diagram showing the system configuration according to an embodiment of the present invention. The system of the present embodiment comprises at least one client 100, at least one server 200 that provides file access services via the NFS protocol or the CIFS protocol, and a version management device 300 that manages file versions between the client 100 and the server 200. The client 100, the server 200, and the version management device 300 each are connected to a local network 1 such as a LAN (Local Area Network) for communication with each other via the local network 1.

The server 200, which has a file system 201 and a storage device 202, receives a file access request from an external device via the NFS protocol or the CIFS protocol and provides data, stored in the storage device 202 and managed by the file system 201, to an external device.

The version management device 300 relays and transfers all requests, received from the client 100 via a specific file access protocol, to the server 200. At the same time, the version management device 300 relays transfers all responses, returned from the server 200 in response to the respective requests, to the client 100.

Therefore, when it becomes necessary for the client 100 to access data in a file stored in the server 200, for example, responsive to the operation of the user who uses an application executed on the client 100, the client 100 sends an access request to the version management device 300 via a specific file access protocol to access the data of the file stored in the server 200.

The devices may be connected to the network 1 in any configuration other than that shown in FIG. 1 as long as a file access packet transferred between the client 100 and the server 200 can be transferred via the version management device 300. For example, it is possible to build separate network segments each composed of the clients 100 and the server 200 and to connect the version management device 300 to both network segments to allow packets to be transferred between the network segments.

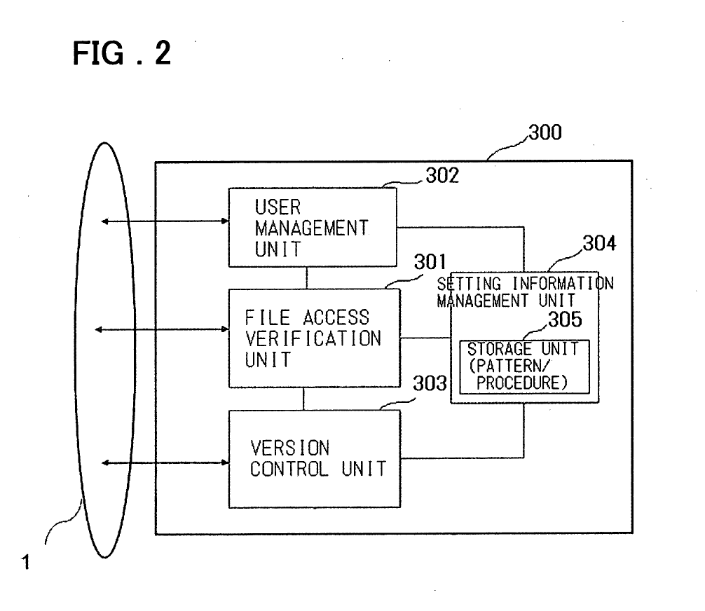

FIG. 2 is a diagram showing an example of the configuration of the version management device 300 shown in FIG. 1. The version management device 300 comprises a file access verification unit 301, a user management unit 302, a version control unit 303, and a setting information management unit 304.

The file access verification unit 301 receives a request packet from the client 100 and a response packet from the server 200, and extracts the processing request from the request packet and the response result from the response packet. The file access verification unit 301 checks if the processing request or the response result matches an access pattern corresponding to the data update processing operation on the file used by the application running on the client 100. Although the access pattern information is stored in a storage unit 305 of the setting information management unit 304 in the configuration shown, the present invention is not limited to this configuration. It is of course possible to store the access pattern information in a storage unit (not shown) in the file access verification unit 301. Although not always required, the access pattern information may be created in such a way that the update processing operation is defined according to a rule in the “if then else” format and, based on the rule, the file access verification unit 301 checks if the operation is the data update processing operation.

The user management unit 302 manages user information in a format, defined for each file access protocol, in order to determine which user has issued the processing request included in a request packet sent from the client 100.

When the file access verification unit 301 executes an operation equivalent to the processing pattern corresponding to the file data update processing executed by the application running on the client 100, this operation of the file access verification unit 301 is used as a trigger to make the version control unit 303 control the creation of a new version management file (abbreviated to “version file”).

The setting information management unit 304 stores operation setting information required (referenced) when the file access verification unit 301, the user management unit 302, and the version control unit 303 perform the respective operations.

Instead of the configuration in which the version management device 300 is configured as a device separate from the server 200 as shown in FIG. 1, the functional units of the version management device 300 may also be included in the server 200.

<Version File Storage Method>

The following describes how the version management device 300 stores a version file in the server 200 when the server 200 is a usual file server or a NAS device that is not equipped with the version management function.

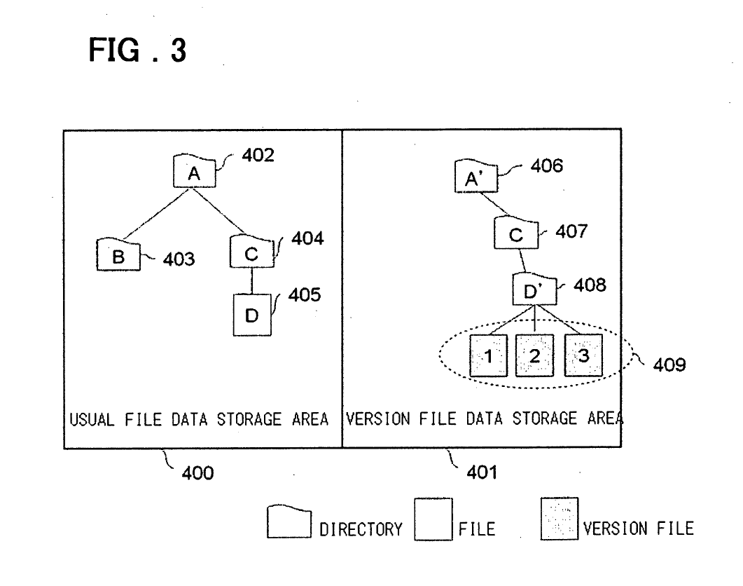

FIG. 3 is a diagram showing an example of how a version file is stored in the server 200. First, in addition to a usual file data storage area 400 to which a usual file access is issued, the client 100 creates a version file data storage area 401, where the version management file is stored, in the file system 201 of the server 200, in a file system newly created from the storage device 202, or on a server separate from the server 200.

If a directory A 402 is open to the clients as a shared directory, the version management device 300 creates a directory A′ 406, corresponding to the directory A 402, in the version file data storage area 401.

When the version file data storage area 401 is created in the server 200, a name different from that of the directory A 402 is assigned to the directory A′ 406 in the version file data storage area 401 to avoid a conflict with the shared name of the directory A 402. The directory A′ 406 is made open to general clients so that it can be accessed as a read-only shared directory.

When creating a new version file, the version management device 300 creates only the objects, which are under the directory A 402 and on the path to the version file storage location, in the version file data storage area 401. If an object on the path to the version file storage location is a directory, the version management device 300 creates a directory C 407 which has the same name as that of a directory C 404 in the usual file data storage area 400 as shown in FIG. 3. On the other hand, if an object below the directory A 402 is a file, that is, if it is a file where the version file is to be created, the version management device 300 creates a directory D′ 408 with its directory name created, for example, by attaching a special word or symbol specific to the version management device 300 to the file name of a file D 405 in the usual file data storage area 400.

An update history data management version file 409 for the file D 405 is saved under the directory D′ 408 with the following information attached to the file name:

Version file creation date/time

User name of the user who has performed operation that becomes a trigger for version creation

Generation management version number.

For example, the file name of the file 409 is “0007_{—}200502281224_yamakawa.doc” where “0007” is the version number, “200502281224” is the creation date/time, and “yamakawa” is the user name of the user who has performed the update.

As described above, in the version file data storage area 401, a version file storage area is created on the directory path similar to that in the usual file data storage area 400 and the created storage area is made open to the client 100. This allows the user of the client 100 to easily access the data of the file in a past generation, stored in the version file data storage area 401, based on the path name of a file stored in the usual file data storage area 400.

The version file storage technique, such as the one shown in FIG. 3, is an example in which the version management device 300 is installed as a switch device as shown in FIG. 1 and the server 200 is an existing file server that uses the NFS protocol or the CIFS protocol. If the server 200 has a version management data storage function, it is also possible to use the storage technique based on the function.

<Version File Creation Condition>

Next, the following describes the version file creation condition of the version management device 300. To determine whether to create a version file, the version management device 300 monitors if an access pattern, which has been registered by a system administrator in advance and which matches the file update processing pattern of an application running on the client, is generated when the version management device 300 receives and transfers a file access protocol packet that is transferred between the client 100 and the server 200.

The file update processing pattern of an application is provided, not for extracting all update processing defined by the protocol, but for extracting only the update processing of a file meaningful enough for the user to keep a version file.

Therefore, the version file creation condition should be a characteristic access pattern characterized in that it is generated when the user updates data and intentionally saves the updated data in the storage device.

The following shows an example of an update processing pattern generated when the user saves data updated using a specific application.

### FIRST EXAMPLE

### Data Saving Operation by Document Creation Application

To prevent the user from losing unsaved update data or data of a file to be edited, a document creation application has the following function to create:

Temporary file (1) in which unsaved editing file data is temporarily saved, and

Temporary file (2) in which data before a data update is temporarily saved.

Such an application creates a temporary file with a characteristic file name for each application. When the user executes the data saving operation, the RENAME processing is performed to substitute the data of the temporary file (1) for the data of the file to be edited, thus reflecting the updated data on the file to be edited.

Therefore, in the document creation application environment such as the one described above, the creation of a version file may be started synchronized with the data saving operation by the user, if the version management device 300 can extract the following:

Generation of “temporary file (1)” or “temporary file (2)”, and

Reflection of updated data from “temporary file (1)” to “file to be edited”.

To create a version file, the temporary file (2), in which data before data updating is stored, is stored into the file version data storage area as a version file of the old version after the updated data is reflected but before the application executes the deletion request.

This procedure produces a version for all files created by the document creation application.

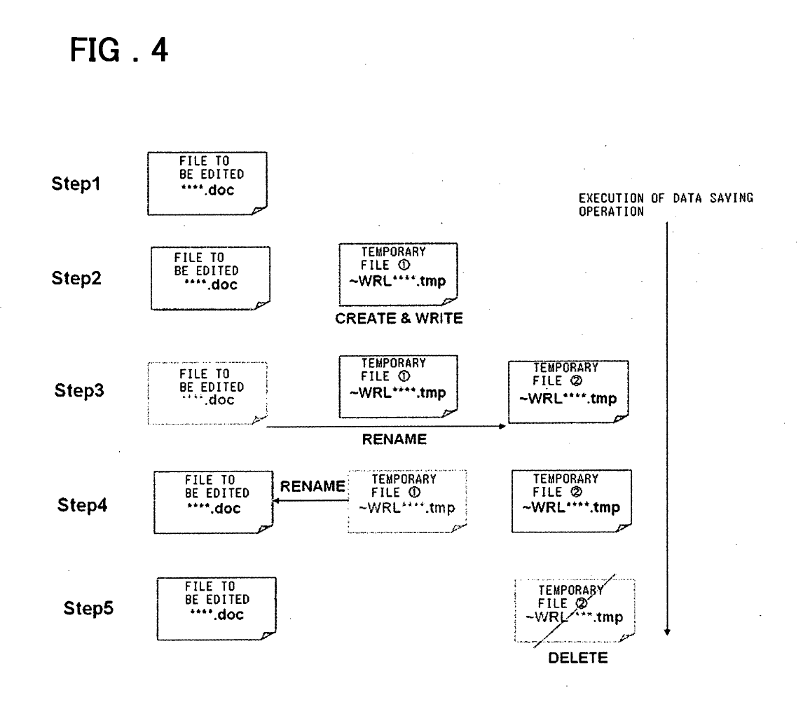

FIG. 4 shows an actual example of a document creation application. In this example, a processing pattern of saving updated data using Microsoft's Office Word (registered trademark) is shown.

When the user saves updated data, Microsoft's Office Word creates:

Temporary file (1) that stores the latest data to which all updated data is reflected, and

Temporary file (2) that stores data before the updated data is saved.

The temporary files have a characteristic file name represented by “˜WRL****.tmp” (where “****” is a string of numbers).

First, the user opens the file to be edited and edits data using the application (Step 1). When the user saves the updated data, the temporary file (1) (“˜WRL****.tmp”) is created in the same directory as that of the file to be edited (Step 2).

In addition, the file to be edited is renamed to the temporary file (2) in the same directory (Step 3), and the temporary file (1) is renamed to the name of the file to be edited (Step 4).

After renaming in Step 4, the temporary file (2) is deleted (Step 5) and the saving processing is completed.

By checking that the execution of the two steps of processing given below is included in the updated data saving processing pattern composed of a sequence of steps by the application described above, it is possible to identify when the version file is created and which file is the source of the version file.

(1) Renaming from “name of file to be edited” to “name of temporary file (2)”, and

(2) Renaming from “name of temporary file (1)” to “name of file to be edited”.

Each of the above two steps of RENAME processing includes a characteristic pattern or extension in the old-file-name and the new-file-name. Therefore, it is determined easily that the processing was executed by the application described above.

From the above description, it is understood that executing two steps of RENAME processing creates the version file and that the source of the version file is the temporary file (2).

Because the temporary file (2) is deleted after Step 4, the version management device 300 copies the data of the temporary file (2) and completes the creation of the version file after receiving a response packet, which indicates that the operation of Step 4 is completed, but before transferring the packet to the client 100.

### SECOND EXAMPLE

### File Overwriting Saving Operation

When the user writes a file over a file with the same name in the copy destination using, for example, the file manager, it is also understood that the user saves the updated data.

When the user executes the operation described above, a file CREATE request is first sent from the client. In response to the request, a file name duplication error is returned from the server.

Upon receiving the error, the application, such as the file manager, prompts the user to select whether to overwrite the file. If the user selects to overwrite the file, one of the following is executed according to the protocol used:

in case of the CIFS protocol, the OPEN request for updating data is sent from the client, followed by the WRITE request, and

in case of the NFS protocol, the WRITE request is sent from the client.

After that, the data of the copy source file is saved in the copy destination file as the updated data.

Therefore, if the version management device 300 can extract a file name duplication error in a response to the CREATE request that is followed by the OPEN request or the WRITE request, the version management device 300 can create a version file synchronously with the overwriting save operation of the file.

To create a version file, the copy source file is stored in the file version data storage area as the version file of the old version at the following time according to the protocol used:

Under the CIFS protocol, after the OPEN request is executed successfully but before the WRITE request is executed

Under the NFS protocol, when the WRITE request is sent

As shown in the two examples given above, the version management device 300 stores in advance,

access pattern that will be generated when the application saves data and

version file creation procedure,

in the storage unit 305 of the setting information management unit 304 (see FIG. 2) and, based on the pattern and procedure, performs:

determining when to create the version file, and

controlling the version file creation operation.

<Information That Should be Set in the Version File Management Device in Advance>

Next, the following describes the items that should be set in the version management device 300 before running the version management device 300 for providing services.

The setting information required for the version management device 300 to provide services is stored in the setting information management unit 304.

The setting information stored in the setting information management unit 304 includes:

IP address or computer name of the server 200 related to version management;

Shared name of a directory open to clients; and

Conditions required for creating a version file synchronously with the saving operation of the application running on the client.

For the conditions, the following conditions are set as in the examples described above according to the environment:

Access request and response result based on the operation of the associated application;

Keyword of the file name corresponding to the operation request;

Protocol used; and

Method for acquiring information required for creating the version file, such as information on the version file storage destination and the version file data copy source.

In addition, in the configuration such as the one shown in FIG. 1, a user on the version management device 300 copies data from the version management device 300 to the server 200, or creates a version file in the server 200, using the super-user authority. Therefore, the account information on the super-user for the server 200 must be registered in the setting information management unit 304.

After entire setting information is registered in the setting information management unit 304, the version management device 300 is ready for starting the services.

<Version File Creation Procedure in CIFS Protocol Environment>

Next, the following describes the procedures used when the configuration shown in FIG. 1 and FIG. 2 and the version file storage method in FIG. 3 are used in the CIFS protocol environment.

<File Access Packet Transfer Procedure>

First, the file access packet transfer procedure used by the version management device 300 will be described.

After the version management device 300 starts the services, the client 100 can access the server 200 via the version management device 300.

The version management device 300 supplies the client with the computer name corresponding to the server 200 to receive a file access packet that would otherwise be sent from the client 100 directly to the server 200.

When a CIFS protocol packet sent from the client 100 arrives the version management device 300, the packet is transferred to the file access verification unit 301.

The file access verification unit 301 extracts the required processing information from the transferred packet and checks if the extracted processing information matches the processing pattern which is registered in the setting information management unit 304 as a trigger for starting the creation of a version file.

After the verification, the version management device 300 performs the processing, that will be described later, according to whether a pattern match occurs, transfers the request packet to the server 200, and waits for a response packet.

When a response packet from the server 200 arrives at the version management device 300, it is transferred to the file access verification unit 301.

The file access verification unit 301 extracts the response result from the response packet, checks if the response is a response to the request processing for the pattern that starts version file creation, performs the processing, that will be described later, according to whether a pattern match occurs, and transfers the response packet to the client 100.

<User Name Management>

The CIFS protocol establishes a session, started by a user's login and ended by a user's logoff, and identifies the user using a user ID efficient only during that session.

Because information about which user's operation has created a version file must be included as a part of the file name of a version file, the version management device 300 must establish the association between a user ID and a user name.

To do so, the version management device 300 establishes the association between the user name and the user ID when the user logs in, and terminates the association when the user logs out.

If the processing request included in the extracted request processing information in a request packet, sent from the client 100 to the version management device 300 and then transferred to the file access verification unit 301, is a user login processing request, the version management device 300 extracts the login user name from the request processing information, associates the request processing identification ID with the login user name, registers the association in the user management unit 302, and transfers the request packet to the server 200.

In addition, regarding the response packet, sent from the server 200 to the version management device 300 and then transferred to the file access verification unit 301, in case of the response packet having the response information which matches the login request processing ID and the response result included in that response information indicating a successful login, the file access verification unit 301 extracts the user ID, which is effective only during this login, from the response result, saves the extracted user ID in the user management unit 302 with the user ID associated with the login user name already registered in the user management unit 302, and transfers the response packet to the client 100.

Conversely, if response result indicates an unsuccessful login, the version management device 300 deletes the login user name and the request processing ID, registered in the user management unit 302 when the request packet was received, and transfers the response packet to the client 100.

Similarly, if the processing request in the request processing information is a user logoff, the version management device 300 extracts the user ID from the request information, registers the extracted user ID and the request processing identification ID in the user management unit 302, and transfers the request packet to the server 200.

Regarding the response packet, sent from the server 200 to the version management device 300 and then transferred to the file access verification unit 301, in case of the response packet having the response information which matches the logoff request processing ID and the response result included in that response information indicating a successful logoff, the file access verification unit 301 deletes the login user name and user ID, which matches the previously registered user ID and the user ID from the user management unit 302, and transfers the response packet to the client 100.

Conversely, if response result indicates an unsuccessful logoff, the version management device 300 deletes the user ID and the request processing ID, registered in the user management unit 302 when the request packet was received, and transfers the response packet to the client 100.

The procedure described above, if executed, establishes the association between a user name and a user ID specified by the packets relayed between the client 100 and the server 200 and specified for login processing and logoff processing. This association allows the version management device 300 to easily extract a user name from a user ID.

<Version File Creation Procedure>

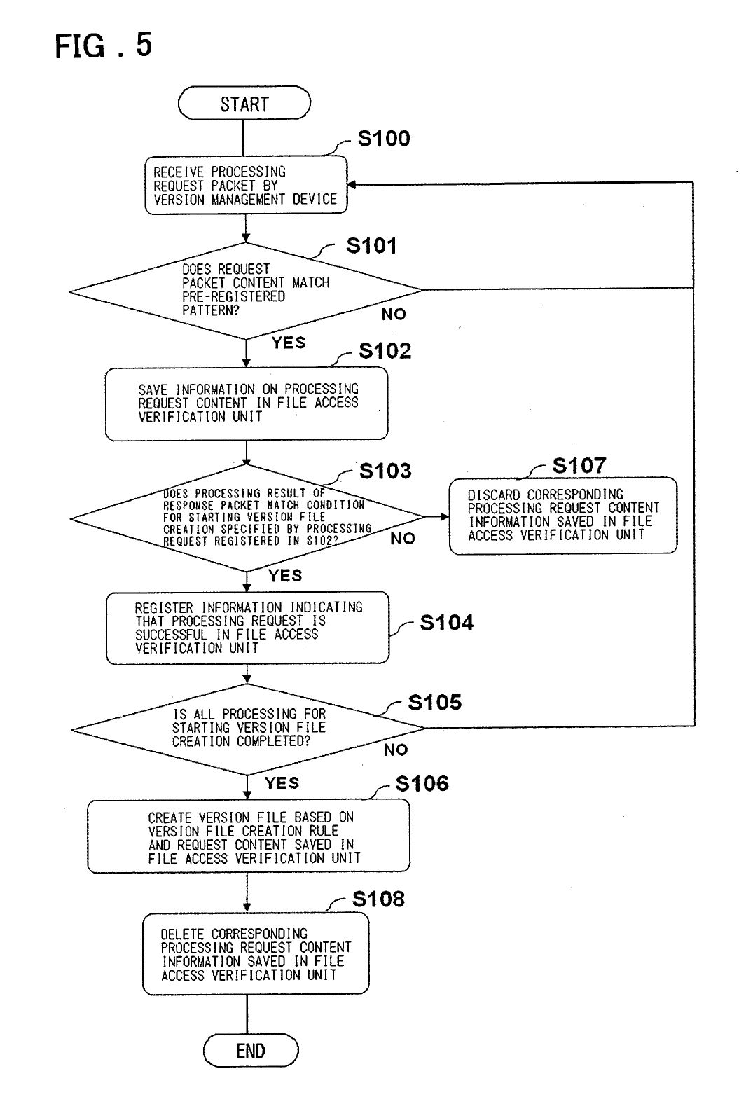

FIG. 5 is a flowchart showing how the version management device 300 creates a version file when the file access verification unit 301 of the version management device 300 finds a processing pattern which is a trigger for starting version file creation. With reference to FIG. 1 and FIG. 5, the following describes a version file creation procedure in one embodiment of the present invention.

The version management device 300 receives a processing request packet sent from the client 100 to the version management device 300 (step S100).

The processing request packet is transferred to the file access verification unit 301 for extracting and analyzing the request processing information. The file access verification unit 301 checks if the content of the processing request packet matches a predetermined pattern (processing pattern registered in the setting information management unit 304 for starting version file creation) (step S101).

If the processing request in the extracted request processing information matches a processing pattern registered in the setting information management unit 304 for starting version file creation (YES in step S101), the information on the processing request content is saved in the storage unit of the file access verification unit 301. More specifically, the path name of the file to be processed, the operation request ID, the user ID, and the command name are extracted and saved in the storage unit provided in the file access verification unit 301 as a processing request entry (step S102). After that, the processing request packet is transferred to the server 200.

The file access verification unit 301 of the version management device 300 extracts a response packet sent from the server 200, which corresponds to the response of the request, from the response packets sent from the server 200 based on the operation request ID, and checks if the response result sent from the server 200 matches the processing pattern for starting version file creation (step S103). If it is found that the response result matches the processing pattern for starting version file creation (YES in step S103), the fact that processing request has been successfully processed is registered in the storage unit in the file access verification unit 301 (step S104). The flag indicating that the response result satisfies the processing pattern is added to the request entry and the response packet is transferred to the client 100.

On the other hand if it is found that the response result does not match the processing pattern for starting version file creation (NO in step S103), the version management device 300 deletes the data included in the request entry and registered when the request was received (step S107), and transfers the response packet to the client 100.

If all processing for starting version file creation is not completed (NO in step S105), control is passed back to step S100 and the version management device 300 waits for a processing request packet.

If all processing for starting version file creation is completed (the condition for starting version file creation is satisfied) (YES in step S105), the version control unit 303 creates a version file based on the version file creation rule and the request content saved in the file access verification unit 301 (step S106).

Just as described, the already-executed operation request is stored temporarily in the request entry and, after that, one or more related operation requests are added to the same request entry. If the processing pattern for starting version file creation matches the operation request and the response result registered in the request entry, the file access verification unit 301 searches the user management unit 302 for a user name matching the user ID saved in the request entry to acquire the user name and, at the same time, acquires the path name, from which the file is copied for version file creation, from the request entry based on the setting information registered in the setting information management unit 304.

The file access verification unit 301 generates the path name, to which the file is copied for version file creation, from the path name according to the method for storing a version file in the version file data storage area 401 and transfers the generated path name, as well as the user name and the path name of the copy source file, to the version control unit 303.

The version control unit 303 acquires the file data and the attribute information stored in the location in the usual file data storage area 400 in the server 200 indicated by the path name, based on the copy source file name acquired from the file access verification unit 301. Similarly, the version control unit 303 creates a new version file in the version file data storage area 401 based on the path name of the copy destination acquired from the file access verification unit 301 and copies the data and the attribute.

If there is neither an existing version file nor a directory to the copy destination when creating the version file, the version control unit 303 first generates the data of the directory and then creates the version file.

In addition, when creating the version file in step S106, the version control unit 303 acquires the version number of an existing version file, which is latest before creating the version file, from the file name of the version file stored in the directory where the version file to be created is to be stored, creates a file name composed of the user name acquired from the file access verification unit 301, the version file creation date/time, and the version number generated by adding 1 to the acquired version number, and assigns the created name to the version file as the file name.

After the creation of the version file is completed, the version control unit 303 sends a version file creation completion notification to the file access verification unit 301. Upon receiving the notification, the file access verification unit 301 deletes the request entry related to the version file (step S108).

<Processing Performed if Request Processing Does not Match Version File Creation Processing Start Pattern, Login Processing, or Logoff Processing>

If the file access verification unit 301 of the version management device 300 finds that the request processing does not match a version file creation start processing pattern, login processing, or logoff processing, the version management device 300 transfers the request packet directly to the server 200.

Similarly, if a response packet does not match a version file creation start processing pattern, the version management device 300 transfers the response packet directly to the client 100.

<Version File Creation Procedure in NFS Protocol Environment>

The version file creation procedure in the NFS protocol environment is similar to that in the CIFS protocol environment except the user name management method in the user management unit 302 and the file creation procedure in the version control unit 303.

Because the NFS protocol is not equipped with the session management function executed during login and logoff, the same user ID is assigned to all operation requests from a particular user. Therefore, the user name to user ID correspondence table, stored in the NIS (Network Information Service) server or the server 200, must be registered in advance in the user management unit 302 in the version management device 300.

In the NFS protocol, a file is handled not by a path name but by an NFS-specific identifier called a “file handle”, and hence the path name of the copy source or copy destination of a version file cannot be uniquely acquired from a packet. This requires that, when a version file is created, the path name beginning at the parent directory of the version file and ending at the open directory must be derived from the file handle of the version file to be created. This operation is executed until the open directory is reached in such a way that the file handle of the parent directory is acquired by file handle+file name “..”, the directory entry is acquired by using the file handle of the parent directory, and the search for a directory name having the acquire file handle is executed.

While the present invention has been described with reference to the embodiment above, it is to be understood that the present invention is not limited to the configuration of the embodiment above and that modifications and changes that may be made by those skilled in the art within the scope of the present invention are included.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A version management device, comprising:
means for analyzing a command context regarding an access to a file to determine whether the command context matches a predetermined pattern, which is registered as a trigger for creating version management information on the file; and
means for creating the version management information on the file if the command context matches said predetermined pattern.

2. A version management device comprising:
storage means for storing a pattern of a data saving access operation, said data saving access operation being one of file access operations; and
control means for analyzing a file access request, issued to a file, comparing the request with said pattern stored in said storage means, and for extracting a file access, which matches said pattern, to control creation of a version management file.

3. The version management device according to claim 2, wherein
an access pattern that is generated when data is saved and a procedure for creating the version management file are registered in said storage means; and wherein
said control means analyzes the file access request to the file and, based on the pattern and the procedure, determines when the version management file is to be created and controls a creation operation of the version management file.

4. The version management device according to claim 1, wherein
said version management device functions as a switch device that relays a file access request, sent from a client to a server, and transfers the file access request to said server, and transfers a response, sent from said server to said client in response to the request, to said client and
monitors the request and the response transferred between said client and said server to check if the file access request matches the pattern.

5. The version management device according to claim 4, wherein
said storage means stores a file update processing pattern of an application running on said client, which is a trigger for the creation of the version management file; said version management device further comprising:
means for receiving a file access protocol packet transferred between said client and said server,
means for monitoring if an access pattern, which matches the file update processing pattern, is generated when the packet is transferred to the server or the client that is a destination, said file update processing pattern being registered in advance as a trigger for starting the creation of the version management file, and
means for creating the version management information, if an access pattern that matches the file update processing pattern is detected.

6. A server device that returns a response to a client responsive to a file access request sent from said client to said server device, comprising
the version management device as defined in claim 2.

7. A version management device that relays and transfers a request received from a client to a server and relays and transfers a response to said client, said request being a server-destined request sent using a pre-defined predetermined file access protocol, said response being sent by said server to said client in response to said request, said version management device comprising:
a file access verification unit, receiving a request packet sent from said client and a response packet sent from said server, for extracting a processing request and a response result included in the received request packet and response packet respectively, and checking if the processing request or the response result matches an access pattern corresponding to a file data update processing operation by an application running on said client;
a user management unit for storing and managing user information in a format corresponding to the predetermined file access protocol to verify from which user the processing request included in the request packet sent from said client is issued;
a version control unit for controlling creation of a version management file when it is found in said file access verification unit that an operation corresponding to the pattern corresponding to the file data update processing by the application running on said client is executed; and
a setting information management unit for storing operation setting information referenced during an operation of said file access verification unit, said user management unit, and said version control unit.

8. The version management device according to claim 7, wherein an access pattern generated when the application running on said client saves data in said server and a procedure for creating the version file are registered in advance in said setting information management unit and
the decision of when to create of the version management file and the control of the creation operation of the version management file are conducted based on the pattern and the procedure.

9. The version management device according to claim 8, wherein, in addition to a usual file data storage area of said server, said version control unit creates a version file data storage area, in which a version management file is stored, in a predetermined file system; wherein
a version management file storage area is arranged in a directory path in the version file data storage area, said directory path being equivalent to a directory path in the usual file data storage area; and wherein
said client can access data of a past generation of a file stored in the version management file data storage area based on a path name of the file stored in the usual file data storage area.

10. The version management device according to claim 8, wherein, in addition to a usual file data storage area of said server, said version control unit creates a version management file data storage area, in which a version management file is stored, in a predetermined file system; and wherein
a version management file for managing file update history data is saved in the version management file data storage area with a file name assigned, said file name including a creation date/time of the version management file, a name of a user who executed an operation for starting version creation, and a version number for generation management.

11. The version management device according to claim 10, wherein
when a directory is laid open to said client as a shared directory in said server, a directory corresponding to the directory is created in the version management file data storage area,
a name not conflicting with a shared name of the directory in the usual file data storage area is assigned to the directory created in the version management file data storage area; and the directory is made open to said client so that said client can access the directory as a read-only shared directory; wherein
objects, which are arranged below the shared directory in the usual file data storage area and which are to be on a path to a version management file storage location, are created in the version management file data storage area when a new version management file is created; wherein
if an object on the path to the version management file storage location is a directory, a directory with the same name as that of the directory in the usual file data storage area is created; and if an object below the directory is a file, a directory with a directory name, generated by adding information specific to the version management device to a file name of the file in the usual file data storage area, is created; and wherein
a version management file for managing file update history data of the file is saved in the directory with a file name assigned, said file name composed of a creation date/time of the version management file, a name of a user who executed an operation for starting version creation, and a version number for generation management.

12. The version management device according to claim 8, wherein said setting information management unit includes:
a server address or a computer name for version management
a shared name of a directory opened to the client and
a condition for creating the version management file synchronously with a saving operation of an application running on the client.

13. The version management device according to claim 12, wherein the condition includes at least one of the access request and the response result based on an operation of an associated application, a keyword of a file name corresponding to the operation request, a corresponding protocol, and an acquisition of a version management file storage destination and a version management file data copy source required for creating the version management file.

14. The version management device according to claim 8, wherein, if the processing request included in extracted request processing information of a request packet sent from said client to said version management device and then transferred to said file access verification unit matches a processing pattern which is a trigger for the creation of the version management file and is registered in said setting information management unit, a path name of a file to be processed, an ID of an operation request, a user ID, and a command name are extracted and then associated and saved in said file access verification unit as a processing request entry and, after that, the request packet is transferred to said server; wherein
a response packet from the server, which corresponds to a response to the request, is extracted based on a request ID and, if it is found that the response result matches the processing pattern which is a trigger for the creation of the version management file, a flag is attached to the request entry indicating that the response result satisfies the processing pattern and, after that, the response packet is transferred to said client; and wherein
if it is found that the response result does not match the processing pattern which is a trigger for the creation of the version management file, data included in the request entry and registered at the request time is deleted and, after that, the response packet is transferred to said client.

15. The version management device according to claim 8, wherein
said file access verification unit generates a path name of a copy destination of version management file creation from a path name according to a procedure for storing version management files in the version management file storage area and transfers the generated path name, as well as a user name and a file path name of a copy source, to said version control unit; and wherein
said version control unit acquires data of a file, which is stored in the path name in a usual file data storage area, and attribute information thereof from said server based on the file path name of the copy source acquired from said file access verification unit, creates a new version management file in a version management file data storage area based on the path name of the copy destination acquired from said file access verification unit, and copies the data and the attribute.

16. The version management device according to claim 8, wherein, when a new version management file is created, said version control unit acquires a version number of a version management file, which is latest before creating the new version management file, from a file name of the version management file stored in a directory where the new version management file is to be stored and assigns a file name, composed of a user name acquired from the file access verification unit, a version management file creation date/time, and a version number generated by adding 1 to the acquired version number, to the new version file.

17. The version management device according to claim 7, wherein, to make said version management device compatible with a system where session management means is not provided for login processing and logoff processing, a user name to user ID correspondence table, stored in a NIS (Network Information Service) server or said server, is registered in said user management unit in said version management device.

18. A version management method comprising:
analyzing a command context regarding an access to a file to determine whether the command context matches a predetermined pattern which is registered as a trigger for the creation of a version management file of the file; and
creating and saving the version management file of the file if the command context matches the predetermined pattern which is a trigger for starting the creation of the version management file.

19. A version management method comprising:
a first step, by a version management device that automatically manages a file version, for receiving a request packet of file processing, for determining if a processing request content of the request packet matches a pre-registered pattern and, if a match occurs, for storing information on the processing request content;
a second step, by said version management device, for receiving a response packet that is a response to the request packet, for determining if the processing request content stored in said first step and a processing result of the response packet match a condition for triggering for starting the creation of a version management file of the file and, if a match occurs, registering information indicating that the processing request is completed; and
a third step, by said version management device, for repeating said first step and said second step until all processing as a trigger for starting the creation of the version management file is completed and, based on the stored request content, for creating the version management file.

20. A computer program for automatically creating a version management file, said program causing a computer to executes the steps of:
analyzing a command context regarding an access to a file to determine whether the command context matches a predetermined pattern which is registered as a trigger for the creation of a version management file of the file; and
creating and saving the version management file of the file if the command context matches the predetermined pattern which is a trigger for starting the creation of the version management file.
